(19) United States
(12) Patent Application Publication
(10) Pub. No.: US 2016/0320068 A1
(43) Pub. Date: Nov. 3, 2016

(54) COOKTOP USER INTERFACE

(71) Applicant: General Electric Company, Schenectady, NY (US)

(72) Inventor: Elliott Dean Koehler, Louisville, KY (US)

(21) Appl. No.: 14/699,045

(22) Filed: Apr. 29, 2015

(51) Int. Cl. F24C 7/08; H05B 6/12; H05B 6/06

(52) U.S. Cl. CPC F24C 7/086; H05B 6/065; H05B 6/12; F24C 7/088

(57) ABSTRACT

A cooktop appliance and a method for operating a cooktop appliance are provided. The cooktop appliance and the method include features for modifying the heating level of at least one heating element of the cooktop appliance and for indicating to a user of the cooktop appliance that the heating level has been modified using a touch user interface. The touch user interface can allow a user to swipe or drag their finger across a power level control strip to control the respective heating element.

### FIELD OF THE INVENTION

The subject matter of the present disclosure relates generally to a cooktop appliance, or more specifically to a user interface for a cooktop appliance.

### BACKGROUND OF THE INVENTION

Cooktop appliances generally include one or more heating elements for cooking food items thereon. The heating elements may include induction heating elements, gas burner heating elements, and/or electric heating elements. A power level of the one or more heating elements may be modified by a user to cook any food items thereon as desired.

Traditionally, one or more knobs or controls are included to allow a user to turn on, set, and modify the power level of each of the heating elements of the cooktop appliance. However, knobs or other physical controls extending above a surface of the cooktop appliance may be aesthetically unpleasing to some users. Further, a user may bump or otherwise knock against the physical controls extending above a surface of the cooktop appliance during cooking operations.

Accordingly, a user interface for a cooktop appliance including controls integrated into a surface of the cooktop appliance would be useful. However, some users are used to traditional controls for cooktop appliances, e.g., control knobs, and may find it difficult to control a cooktop appliance without these traditional controls.

Therefore, an intuitive user interface for a cooktop appliance would be useful. More particularly, an intuitive user interface for a cooktop appliance integrated into a surface of the cooktop appliance would be particularly beneficial.

### BRIEF DESCRIPTION OF THE INVENTION

Aspects and advantages of the invention will be set forth in part in the following description, may be apparent from the description, or may be learned through practice of the invention.

In a first exemplary embodiment, a cooktop appliance is provided. The cooktop appliance includes a heating element for heating food items and a touch user interface defining a top surface and a power level control strip extending along the top surface between a first end and a second end. The cooktop appliance additionally includes a controller operably connected to the heating element and the touch user interface. The controller is configured to receive a user input through the touch user interface in the form of a user touch at a location on the power level control strip. The controller is further configured to adjust a power level of the heating element to a power level corresponding to the location of the user touch on the power level control strip.

In a second exemplary aspect, a method for controlling a cooktop including a heating element, a touch user interface, and an array of lighting elements is provided. The method includes receiving a user input through a power level control strip defined by the touch user interface and extending along a top surface of the touch user interface, and adjusting a power level of the heating element based on the user input received through the power level control strip defined by the touch user interface. The method also includes illuminating with one or more lighting elements in the array of lighting elements a portion of the touch user interface indicative of the power level of the heating element.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of a cooktop appliance received within a set of kitchen cabinets according to an exemplary embodiment of the present subject matter.

FIG. 2 provides a top view of a touch user interface accordance with an exemplary embodiment of the present disclosure.

FIG. 3 provides a close-up view of a first power level control strip defined by the exemplary touch user interface of FIG. 2.

FIG. 4 provides another close up view of the first power level control strip defined by the exemplary touch user interface of FIG. 2.

FIG. 5 provides a flow diagram of a method for controlling a cooktop appliance in accordance with an exemplary aspect of the present disclosure.

FIG. 6 provides a flow diagram of a method for controlling a cooktop appliance in accordance with another exemplary aspect of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

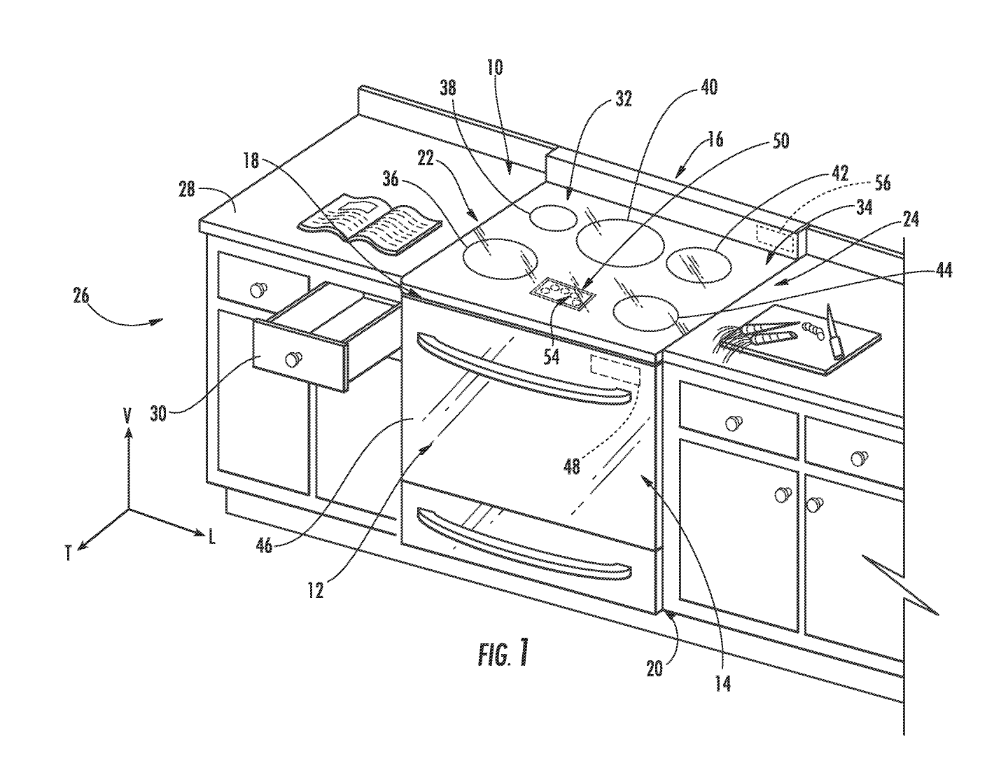

FIG. 1 provides a perspective view of a cooktop appliance 10 including an oven 12 received within a set of kitchen cabinets. Cooktop appliance 10 extends between a front end 14 and a rear end 16 along a transverse direction T, between a top end 18 and a bottom end 20 along a vertical direction V, and between a left side 22 and a right side 24 along a lateral direction L. The kitchen cabinets depicted in FIG. 1 include a base set 26 of kitchen cabinets extending along the lateral direction L. Base set 26 of kitchen cabinets includes countertops 28 and drawers 30. Cooktop appliance 10 is received within base set 26 of kitchen cabinets. Although not depicted, kitchen cabinets may also include a top set of kitchen cabinets with a range or hood positioned over the cooktop appliance 10 along the vertical direction V.

Cooktop appliance 10 includes a plurality of heating elements (referred to generally as numeral 32), e.g., electrical resistive heating elements, gas burners, induction heating elements, and/or any other suitable heating element or combination of heating elements. More particularly, for the embodiment depicted, cooktop appliance 10 includes five induction heating elements 32 positioned on a top surface 34 of the cooktop appliance 10 (i.e., a first heating element 36, a second heating element 38, a third heating element 40, a fourth heating element 42, and a fifth heating element 44). Cooking utensils may be placed on heating elements 32 to cook or heat food items. Oven 12 also includes a door 46 that permits access to a cooking chamber (not shown) of the oven 12 of cooktop appliance 10, e.g., for cooking or baking of food items therein. Further, oven 12 of cooktop appliance 12 includes a door lock 48 that, when engaged, prevents door 46 from opening. Door lock 48 may be an electromechanical lock or any other suitable locking device.

Cooktop appliance 10 additionally includes touch user interface 50. For the embodiment depicted, the touch user interface 50 is positioned at a middle portion of the cooktop appliance 10 along the lateral direction L (i.e., between left side 22 and right side 24) and proximate front end 14 of the cooktop appliance 10 along the transverse direction T. Additionally, the touch user interface 50 defines a top surface 52 that is flush with the top surface 34 of the cooktop appliance 10. More particularly, for the embodiment depicted, the top surface 34 of the cooktop appliance 10 may be the same material as the top surface 52 of the touch user interface 50, such as for example, a glass material. Further, the top surfaces 34, 52 of the cooktop appliance 10 and touch user interface 50, respectively, may be comprised of a single, continuous material. Such a configuration may provide a more convenient and aesthetically desirable configuration for the user interface for the cooktop appliance 10. More particularly, such a configuration may reduce a chance that a user may bump against or get snagged on a user interface including, e.g., physical knobs extending above the top surface of the cooktop appliance 10.

The touch user interface 50 may include any suitable touch interface technology. For example, the touch user interface 50 may utilize capacitive sensing technology, resistive touch sensing technology, or any other suitable technology capable of receiving a user input in the form of a user touch on the top surface 52 of the touch user interface 50. Accordingly, in certain exemplary embodiments, the touch user interface 50 may include one or more coatings or other physical attributes not otherwise described herein.

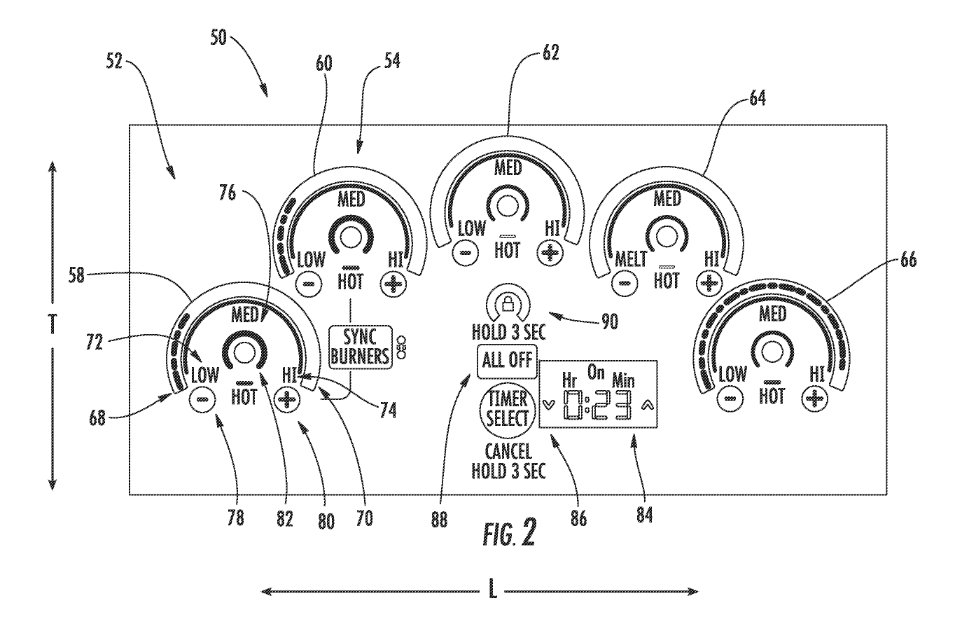

As will be described in greater detail below with reference to FIG. 2, the touch user interface 50 defines a plurality of power level control strips (referred to generally as numeral 54) extending along the top surface 52 of the touch user interface 50, each configured to control a power level of one of the plurality of heating elements 32. Additionally, as will be discussed in greater detail below, the cooktop appliance 10 also includes a plurality of lighting elements (not shown). More particularly, an array of lighting elements is provided for each of the power level control strips 54. Each array of lighting elements extends along a respective power level control strip below the top surface 52 of the touch user interface 50 along the vertical direction V for illuminating a portion of the touch user interface indicative of a power level of the respective heating element. For example, in certain exemplary embodiments, each array of lighting elements may be configured to illuminate a portion of the respective power level control strip. In certain exemplary aspects, one or more of the array of lighting elements may be configured as an array of light emitting diodes (LEDs). It should be appreciated, however, that in other exemplary embodiments, the each array of lighting elements may instead be configured to illuminate any other portion of the touch screen user interface 50 indicative of the power level of the respective heating element. For example, in other exemplary embodiments, each array of lighting elements may be configured to illuminate an outside portion of the respective power level control strip 54, such as one or both outside edges of the respective power level control strip 54, in addition to or instead of the respective power level control strip 54 itself. Such a configuration may ensure a user is able to see a power level of the respective heating element as such user adjusts the power level of such heating element.

The operation of the cooktop appliance 10 and heating elements, is controlled by a processing device such as a controller 56 (shown in phantom), which may include a microprocessor or other device that is in operable communication with such components. For example, in the embodiment depicted, controller 56 is operatively coupled or in communication with the heating elements 32, the touch user interface 50, and the arrays of lighting elements. Additionally, the controller 56 may be operatively coupled with various other components of the cooktop appliance 10, such as the range 12 including, e.g., the door lock 48. In response to user manipulation of the touch user interface 50, the controller 56 may operate the cooktop appliance 10 to execute selected cycles and features.

Controller 56 may include a memory and microprocessor, such as a general or special purpose microprocessor operable to execute programming instructions or micro-control code. The memory may represent random access memory such as DRAM, and/or read only memory such as ROM or FLASH. In one embodiment, the processor executes programming instructions stored in memory. The memory may be a separate component from the processor or may be included onboard within the processor. Heating elements 32, touch user interface 50, the arrays of lighting elements, and other components of the cooktop appliance 10 and oven 12 may be in communication with controller 56 via one or more signal lines or shared communication busses.

It should be appreciated, however, that the cooktop appliance 10 described herein with reference to FIG. 1 is provided by way of example only and is not intended to limit the present subject matter in any aspect. Thus, the present subject matter may be used with other cooktop appliance 10 configurations, e.g., cooktop appliances having only a cooktop or including oven 12 appliances that define one or more interior cavities for the receipt of food. Further, the present subject matter may be used in any other suitable appliance.

Referring now to FIG. 2, a top view of the touch user interface 50 is provided. As previously stated, the exemplary touchscreen user interface defines five (5) power level control strips 54, each control strip configured to control a power level of a respective heating element of the cooktop appliance 10. More particularly, for the embodiment depicted, the touch user interface 50 defines a first power level control strip 58 configured to control a power level of a first heating element 36 (FIG. 1); a second power level control strip 60 configured to control a power level of a second heating element 38 (FIG. 1); a third power level control strip 62 configured to control a power level of a third heating element 40 (FIG. 1); a fourth power level control strip 64 configured to control a power level of a fourth heating element 42 (FIG. 1); and a fifth power level control strip 66 configured to control a power level of a fifth heating element 44 (FIG. 1).

Additionally, for the embodiment depicted, the power level control strips 54 each define a semicircular shape extending between a first end 68 and a second end 70. The first ends 68 of the power level control strips 54 correspond to a low power level of the respective heating elements 32 and the second ends 70 of the power level control strips 54 correspond to a high power level of the respective heating elements 32. Moreover, each of the power level control strips 54 depicted defines a plurality of discrete locations between the respective first end 68 and the second end 70. Each of the discrete locations corresponds to a power level of the respective heating element. For example, in certain exemplary embodiments, one or more of the power level control strips 54 may include twenty discrete locations positioned between the first end 68 and second end 70. Each of the twenty discrete locations positioned between the first end 68 and the second end 70 may correspond to different power levels of the respective heating element. Moreover, each of the sequential discrete locations may correspond to sequential and incremental increases or decreases in the power level of the respective heating element. In other exemplary embodiments, however, each of the power level control strips 54 may include any other suitable number of discrete locations between the respective first end 68 and second end 70.

For the embodiment depicted, the touch user interface 50 further includes a plurality of indicia proximate to each of the power level control strips 54 configured to indicate to a user a power level corresponding to certain of the discrete locations. For example, with reference to the first power level control strip 58, the touch user interface 50 includes an indicia 72 at the first end 68 labeled “LOW,” an indicia 74 at the second end 70 labeled “HI,” and an indicia 76 between the first end 68 and the second end 70 labeled “MED.” Such indicia 72, 74, 76 indicate to a user a power level of the first heating element 36 corresponding to certain locations along the first power level control strip 58.

The touch user interface 50 additionally includes other power level control touch interfaces for each of the heating elements 32 proximate to the respective power level control strips 54. For example, the touch user interface 50 additionally includes a “minus” touch interface button 78, a “plus” touch interface button 80, and a “power” touch interface button 82 proximate to each of the power level control strips 54. For the exemplary embodiment depicted, the minus touch interface buttons 78 are positioned proximate to the first end 68 of each power level control strip 54 and may be used to incrementally decrease a power level of a respective heating element 32. The plus touch interface buttons 80 are positioned proximate to the second end 70 of each power level control strip 54 and may be used to incrementally increase a power level of a respective heating element 32. Additionally, the power touch interface buttons 82 are positioned at a center of the semicircular shaped power level control strips 54 and may be used to toggle power to a respective heating element 32, i.e., to turn the respective heating element 32 “on” or “off.” Notably, as used herein, the term “button” may refer to an area defined by top surface 52 of the touch user interface 50 configured to receive a user input in the form of, e.g., a user touch.

Further, the touch user interface 50 additionally includes other control and display elements. For example, the exemplary interface 50 depicted additionally includes a timer display 84 and timer control buttons 86. Additionally, the interface defines an “all off” button 88, which may be configured to turn off all heating elements 32 in response to receipt of a user touch, and a “lock” button 90 which may be used to lock the touch user interface 50 such that a user does not accidentally activate one or more of the heating elements 32. It should be appreciated, however, that the exemplary touch user interface 50 depicted is by way of example only. In other exemplary embodiments, for example, the interface 50 may define any other suitable inputs or controls, and/or any other suitable configuration of the depicted inputs and controls. Additionally, other exemplary interfaces 50 may define any other suitable number of power level control strips 54, any other suitable shape for one or more of the power level control strips 54, and/or any other suitable indicia (if any) proximate to the power level control strips 54.

Referring particularly to the first power level control strip 58 and the first heating element 32 (FIG. 1), the controller 56 is configured to receive a user input through the touch user interface 50 in the form of a user touch at a location on the first power level control strip 58. In response, the controller 56 is configured to adjust a power level of the heating element 32 to a power level corresponding to the location of the user touch on the power level control strip 58. Moreover, the controller 56 is configured to provide real time feedback to the user regarding the power level of the respective heating element 32. For example, the controller 56 may be further configured to illuminate a portion of the power level control strip 58 (and/or one or more edges of the power level control strip 58) between the first end 68 of the power level control strip 58 and the location of the user touch on the power level control strip 58 using one or more lighting elements in a respective array of lighting elements.

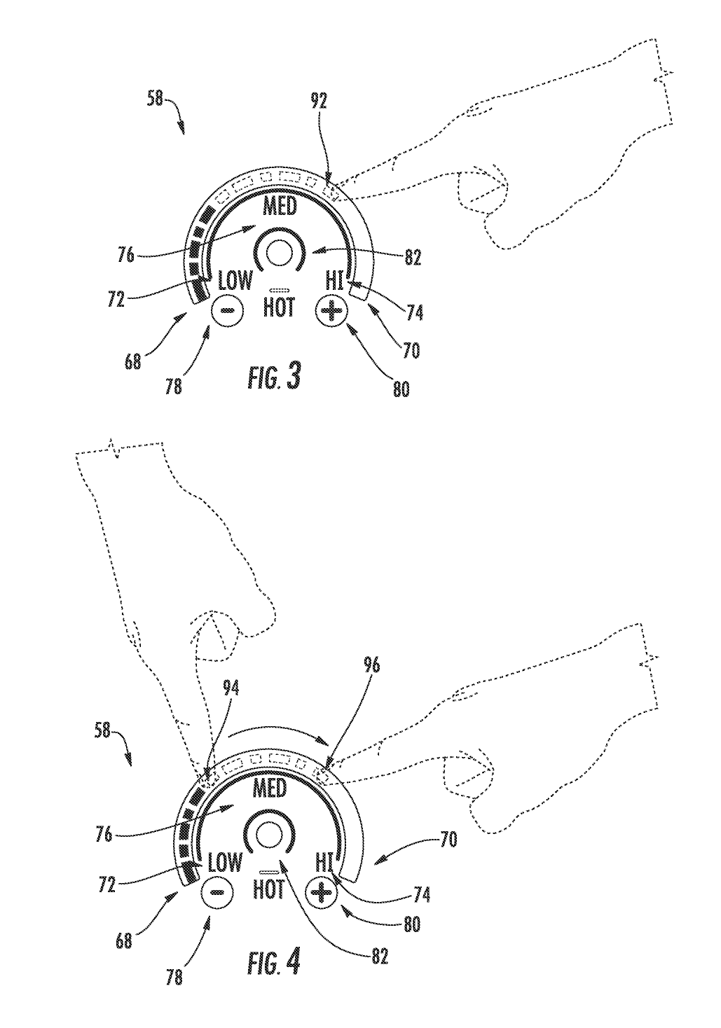

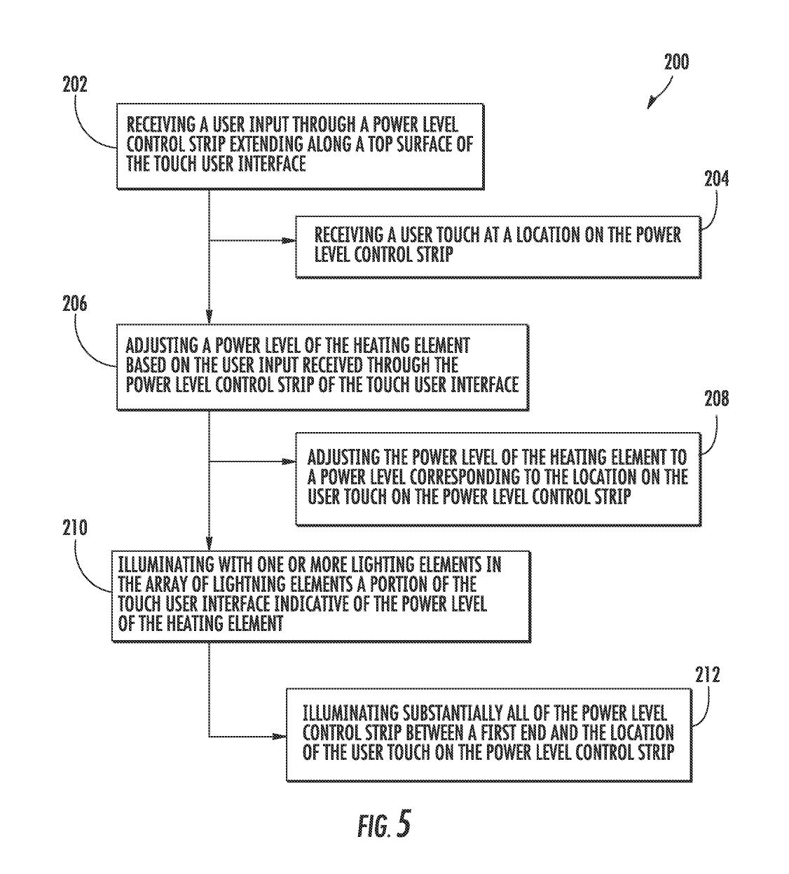

Referring now to FIGS. 3 and 4, operation of the cooktop appliance 10 will be described in greater detail.

FIG. 3 shows a close up view of the first power level control strip 58 of the touch user interface 50, with a user touch being shown on the power level control strip 58 in phantom. Prior to the user touch, the heating element 36 is being operated at about a forty percent (40%) power level, as indicated by one or more lighting elements of the array of lighting elements illuminating a corresponding portion of the power level control strip 58 (i.e., the first forty percent (40%) of the power level control strip 58). For the embodiment depicted, the user touch is a single touch at a single location 92 on the power level control strip 58. The single location 92 of the user touch on the power level control strip 58 is a location approximately sixty percent (60%) along the power level control strip 58, corresponding to an approximately sixty percent (60%) power level. Responsive to receiving the user input the form of the user touch at the single location 92, the controller 56 is configured to adjust the power level the first heating element 36 to a power level corresponding to the single location 92 of the user's touch. More particularly, the controller 56 is configured to adjust the power level of the first heating element 36 to an approximately sixty percent (60%) power level. Additionally, the controller 56 substantially simultaneously (i.e., within about one second or less) illuminates a portion of the power level control strip 58 between the first end 68 and the single location 92 of the user's touch to give the user real time feedback of the control of the first heating element 36. It should be appreciated, that as used herein, terms of approximation, such as “substantially” and “approximately” refer to being within a ten percent (10%) margin of error.

Referring now to FIG. 4, another close-up view of the first power level control strip 58 of the touch user interface 50 is shown, with the user touch being shown on the power level control strip 58 in phantom. For the embodiment depicted, user touch is a swipe across a portion of the power level control strip 58 between a first position 94 and a second position 96. More particularly, for the embodiment depicted, the user touch includes an initial user touch at the first position 94 and subsequently the user touch dragging from the first position 94, along the power level control strip 58, and to the second position 96. With such an exemplary embodiment, the controller 56, may be configured to adjust the power level of the heating element 36 to correspond with a power level at the second position 96 of the user swipe. For example, when the user touch initially is at the first position 94, the controller 56 may adjust the power level of the heating element 36 to the power level corresponding to the first position 94 on the power level control strip 58. Subsequently, as the user touch drags from the first position 94 along the power level control strip 58 to the second position 96, the controller 56 may correspondingly adjust the power level of the heating element 36 to correspond with the position of the user touch along the power level control strip 58. Such adjustments may be made substantially simultaneously with the receipt of the user touch on the first power level control strip 58 (i.e. within about one (1) second or less).

Furthermore, the controller 56 upon receipt of user input in the form of the user swipe may also be configured to activate one or more lighting elements in the array of lighting elements to substantially illuminate the power level control strip 58 between the first end 68 and the second position 96 on the power level control strip 58. More particularly, as with adjusting the power level of the heating element 36, when the user touch is initially at the first position 94, the controller 56 may illuminate the power level control strip 58 between the first end 68 and the first position 94. Subsequently, at the user drags from the first position 94, along the power level control strip 58, and to the second position 96, the controller 56 may correspondingly substantially illuminate such portions of the power level control strip 58 over which the user touch is dragged to provide a real-time feedback to the user of the power level of the heating element 36. In certain exemplary embodiments, such corresponding illumination may be done substantially simultaneously with the dragging of the user touch (i.e., within about one (1) second or less).

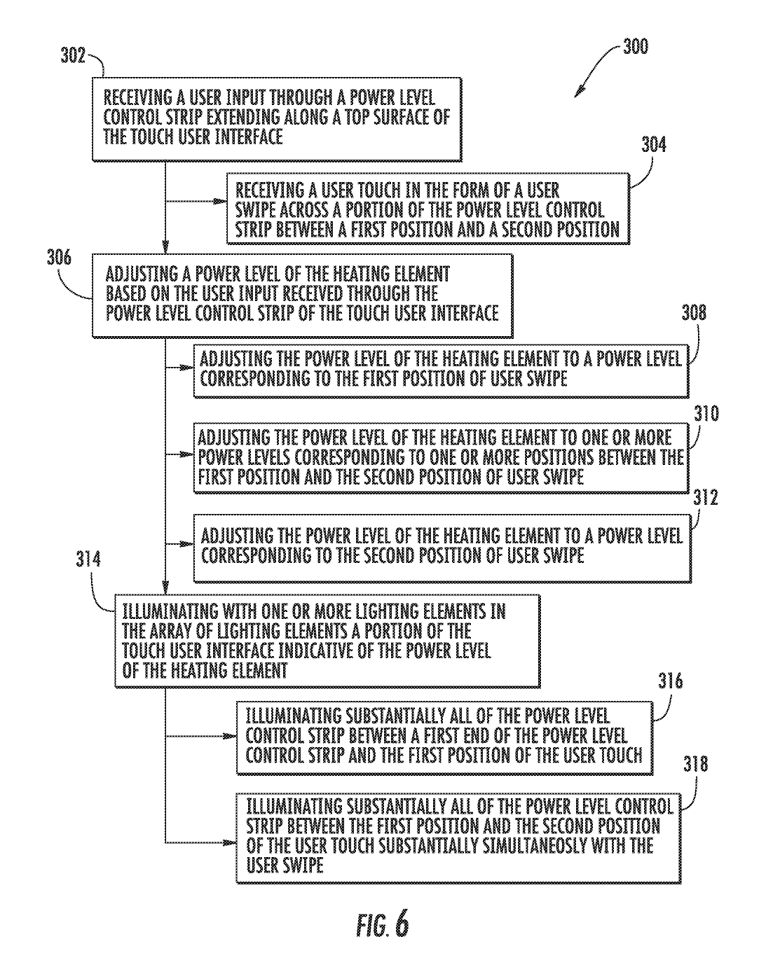

Referring now to FIG. 5, a method (200) for controlling a cooktop appliance including a heating element, a touch user interface, and an array of lighting elements is provided. The method (200) may be used in certain exemplary aspects to control the cooktop appliance 10 described above reference to FIGS. 1 through 4.

The exemplary method (200) includes receiving at (202) a user input through a power level control strip defined by the touch user interface and extending along a top surface of the touch user interface. More particularly, for the exemplary aspect depicted, receiving the user input at (202) includes at (204) receiving a user touch at a location of the power level control strip. The user touch may be a user pressing their finger against the power level control strip at the location.

Additionally, the exemplary method (200) includes at (206) adjusting a power level of the heating element based on the user input received through the power level control strip of the touch user interface. More particularly, the exemplary method (200) depicted includes at (208) adjusting the power level of the heating element to a power level corresponding to the location of the user touch on the power level control strip. Such an adjustment at (208) may take place substantially simultaneously with the receipt of the user touch on the power level control strip at (204) (i.e., within about one (1) second or less). Referring still to FIG. 5, the exemplary method (200) additionally includes at (210) illuminating with one or more lighting elements in the array of lighting elements a portion of the touch user interface indicative of the power level of the heating element. More particularly, for the exemplary aspect depicted, illuminating a portion of the touch user interface at (210) includes at (212) illuminating substantially all the power level control strip between a first end and the location of the user touch on the power level control strip.

Referring now to FIG. 6, another method (300) for controlling a cooktop appliance including a heating element, a touch user interface, and an array of lighting elements is provided. As with the exemplary method (300) of FIG. 5, the exemplary method of FIG. 6 may be used in certain aspects to control the cooktop appliance 10 described above with reference to FIGS. 1 through 4.

The exemplary method (300) of FIG. 6 similarly includes at (302) receiving a user input through a power level control strip defined by the touch user interface and extending along a top surface of the touch user interface. However, for the embodiment depicted, receiving a user input through the power level control strip at (302) includes at (304) receiving a user touch in the form of a user swipe across a portion of the power level control strip between a first position and a second position. For example, a user may use their finger to touch the power level control strip at the first position and drag their finger along the power level control strip from the first position to the second position.

The exemplary method (300) also includes at (306) adjusting a power level of the heating element based on the user input received through the power level control strip. For the embodiment depicted, adjusting the power level at (306) includes adjusting the power level of the heating element to a power level corresponding to the second position of the user swipe on the power level control strip. Particularly, adjusting the power level at (306) includes at (308) adjusting the power level of the heating element to a power level corresponding to the first position of user swipe, and subsequently at (310) adjusting the power level of the heating element to one or more power levels corresponding to one or more positions between the first position and the second position of user swipe. Finally, adjusting the power level at (306) includes at (312) adjusting the power level of the heating element to a power level corresponding to the second position of user swipe. Such adjustments of the power level of the heating element may be made substantially simultaneously with the user swipe (i.e., within about one (1) second or less).

Furthermore, the method (300) includes at (314) illuminating with one or more lighting elements in the array of lighting elements a portion of the power level control strip indicative of the power level of the heating element. Particularly for the embodiment depicted, the method (300) includes at (316) illuminating substantially all of the power level control strip between a first end of the power level control strip and the first position of the user swipe. The exemplary method (300) subsequently includes at (318) illuminating substantially all of the power level control strip between the first position and the second position of the user swipe, substantially simultaneously with the user swipe (i.e., within about one (1) second or less). Accordingly, the exemplary aspect depicted may provide a user real-time feedback of a power level of the heating element of the cooktop appliance.

A system in accordance with one or more of the embodiments described above with reference to FIGS. 1 through 4 or a method in accordance with one or more of the exemplary aspects described above with reference to FIG. 5 or FIG. 6, may provide a user-intuitive method for controlling a cooktop appliance. More particularly, by including a touch user interface defining one or more power level control strip configured to receive a user input in the form of a single touch at a single location (and “jump” to such corresponding power level) or a user swipe across a portion of the strip (and adjust to the ending location of such swipe), a user may intuitively adjust a power level of a respective heating element. Further, by defining the power level control strips as semicircular power level control strips, a user may draw on prior experiences with other physical control interfaces for cooktop appliances (e.g., knobs) to figure out how to operate the cooktop appliance.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A cooktop appliance comprising:
a heating element for heating food items;
a touch user interface defining a top surface and a power level control strip extending along the top surface between a first end and a second end; and
a controller operably connected to the heating element and the touch user interface, the controller configured to
receive a user input through the touch user interface in the form of a user touch at a location on the power level control strip; and
adjust a power level of the heating element to a power level corresponding to the location of the user touch on the power level control strip.

2. The cooktop appliance of claim 1, wherein the first end of the power level control strip corresponds to a low power level and the second end of the power level control strip corresponds to a high power level.

3. The cooktop appliance of claim 1, wherein the power level control strip defines a plurality of discrete locations between the first end and the second end, and wherein each discrete location corresponds to a power level of the heating element.

4. The cooktop appliance of claim 3, wherein the touch user interface further includes a plurality of indicia proximate to the power level control strip configured to indicate to a user a power level corresponding to certain of the discrete locations.

5. The cooktop appliance of claim 1, wherein the power level control strip defines a semi-circular shape.

6. The cooktop appliance of claim 1, wherein the user touch at a location on the power level control strip is a user touch at a single location on the power level control stip.

7. The cooktop appliance of claim 1, wherein the user touch at a location on the power level control strip is a user swipe across a portion of the power level control strip between a first position and a second position, and wherein adjusting a power level of the heating element includes adjusting the power level of the heating element to a power level corresponding to the second position.

8. The cooktop appliance of claim 1, further comprising
an array of lighting elements extending along the power level control strip below the top surface of the touch user interface for illuminating a portion of the power level control strip, wherein the controller is further configured to illuminate a portion of the power level control strip between the first end of the power level control strip and the location of the user touch on the power level control strip.

9. The cooktop appliance of claim 1, further comprising
a second heating element, wherein the touch user interface additionally includes a second power level control strip, wherein the controller is also operably connected to the second heating element and is configured to control the second heating element in response to a user input received through the touch user interface in the form of a user touch at a location on the second power level control strip.

10. The cooktop appliance of claim 1, wherein the top surface of the touch user interface is flush with a top surface of the cooktop.

11. The cooktop appliance of claim 1, wherein the array of lighting elements are light emitting diodes.

12. A method for controlling a cooktop including a heating element, a touch user interface, and an array of lighting elements, the method comprising:
receiving a user input through a power level control strip defined by the touch user interface and extending along a top surface of the touch user interface;
adjusting a power level of the heating element based on the user input received through the power level control strip defined by the touch user interface; and
illuminating with one or more lighting elements in the array of lighting elements a portion of the touch user interface indicative of the power level of the heating element.

13. The method of claim 12, wherein receiving the user input includes receiving a user touch at a location on the power level control strip.

14. The method of claim 13, wherein illuminating the portion of the touch user interface indicative of the power level of the heating element includes illuminating substantially all of the power level control strip between a first end and the location of the user touch on the power level control strip.

15. The method of claim 13, wherein adjusting the power level of the heating element includes adjusting the power level of the heating element to a power level corresponding to the location on the user touch on the power level control strip.

16. The method of claim 12, wherein receiving the user input includes receiving a user touch in the form of a user swipe across a portion of the power level control strip between a first position and a second position.

17. The method of claim 16, wherein illuminating the portion of the touch user interface indicative of the power level of the heating element includes
illuminating substantially all of the power level control strip between a first end of the power level control strip and the first position of the user touch; and
illuminating substantially all of the power level control strip between the first position and the second position of the user touch substantially simultaneously with the user swipe.

18. The method of claim 16, wherein adjusting the power level of the heating element includes adjusting the power level of the heating element to a power level corresponding to the second position of the user swipe on the power level control strip.

19. The method of claim 16, wherein the adjusting the power level of the heating element includes adjusting the power level of the heating element to a power level corresponding to a first position of the user swipe, to one or more positions between the first position and the second position of the user swipe, and subsequently to the second position of the user swipe, all substantially simultaneously with the user swipe.

20. The method of claim 11, wherein the array of lighting elements is an array of light emitting diodes.
